(19) United States
(12) Patent Application Publication
(10) Pub. No.: US 2015/0072067 A1
(43) Pub. Date: Mar. 12, 2015

(54) METHOD OF MANUFACTURE OF A PIECE DESIGNED TO BE FITTED IN THE AREA OF A DENTAL PROSTHESIS IN THE MOUTH OF A PATIENT

(71) Applicant: BIOTECHNOLOGY INSTITUTE, I MAS D, S.L., Vitoria (Alava) (ES)

(72) Inventor: Eduardo ANITUA ALDECOA, Vitoria (Alava) (ES)

(21) Appl. No.: 14/049,394

(22) Filed: Oct. 9, 2013

(30) Foreign Application Priority Data
Sep. 10, 2013 (ES) P 201200991

(51) Int. Cl. A61C 8/00; A61C 13/00

(52) U.S. Cl. CPC A61C 8/0013; A61C 13/0018
USPC 427/2.26

(57) ABSTRACT

Method of manufacture of a piece designed to be fitted in the area of a dental prosthesis in the mouth of a patient, which comprises creating sugosities on the outer surface of the piece and applying a layer of TiN on the piece. The pieces allow the aesthetic results of the prosthetic treatment to be enhanced. It has also been shown that the manufactured pieces inhibit bacterial adhesion and are biocompatible.

### TECHNICAL FIELD

The invention relates to a method of manufacture of a piece designed to be fitted in the area of a dental prosthesis in the mouth of a patient.

### PRIOR ART

In the field of the manufacture of pieces related to dental medicine, it is currently known to have layers of titanium nitride (also known as Tinite or TiN) applied on pieces or components made from alloys of titanium, steel, etc. Titanium nitride is a very hard ceramic material that improves certain properties of the pieces, mainly, their resistance to wear and corrosion, while also giving the pieces a surface colour similar to that of gold. Usually, TiN layers are applied on temporary-use pieces or components, for example on surgical instruments such as screwdriver tips or ultrasound devices, which are not designed to come into contact with the patient's tissues. The purpose of TiN being applied on such pieces is to make them more wear-resistant, so they can better withstand frequent contact with hard materials (bone) and constant sterilisation cycles, and also to make them more corrosion-resistant, so they can withstand frequent contact with highly corrosive body fluids during regular use of the pieces.

The application of TiN layers on pieces designed to be fitted in a non-temporary manner in the mouth of the patient is also known in prior art. In particular, the application of TiN layers on dental implants has been described. For example, patent application no. EP1005840A2 describes the application of a TiN layer for creating implants with a yellow tone very similar to that of gold, therefore allowing the implant to blend into the gum with results that are virtually as aesthetically pleasing as when gold pieces (made entirely of gold or coated in gold) are used, but at a much lower cost. Gold pieces have very favourable mechanical properties, in particular high resistance and pre-tension effects that are desirable in the event of having to withstand large masticatory forces, bruxism and other complex conditions. However, on many occasions, the only reason why gold pieces are applied to a patient is the excellent aesthetic finish they offer (especially when they are situated beneath the gum, as they do not affect its natural colouring). On such occasions, it would be desirable to have an alternative to gold that is just as aesthetically pleasing but less costly.

Despite the need, the practice of applying layers of TiN to dental implants has not become widespread, mainly for the following reasons. Firstly, it is very hard to control the thickness of the TiN layer and to keep it below 3 to 4 microns, which is the manufacturing tolerance of the implant. Secondly, it has not been possible to formulate a coating that is biocompatible with human tissue, and whose specific machined-surface topography inhibits bacterial adhesion.

It is an objective of this invention to provide a method of manufacture of a piece designed to be fitted in the area of a dental or transepithelial prosthesis in the mouth of a patient, which is provided with an outer coating of TiN of a very small thickness, no greater than four microns, and which is also biocompatible with human tissue and inhibits bacterial adhesion.

### BRIEF DESCRIPTION OF THE INVENTION

It is an object of this invention to provide a method of manufacture of a piece designed to be fitted in the area of a dental or transepithelial prosthesis in a patient's mouth. The method comprises the following steps:
creating rugosities on the outer surface of a piece manufactured from titanium, stainless steel, gold or their alloys, for example by applying a laser treatment on the surface or by subjecting the piece to an acid treatment (acid etching);
applying a layer of TiN on the piece.

In a first embodiment, which is of particular interest in the event that the piece is a dental implant, the step of applying a TiN layer is performed first, and the step of creating rugosities on the outer surface of the piece is carried out at a later stage. The application of a TiN layer provides the implant with a TiN coating that has a smooth and evened outer surface in comparison to the original piece, the TiN layer generally being thicker than the tolerance of the implant (generally 4 microns). The subsequent creation of roughness allows reducing the thickness of the TiN layer, thereby ensuring that the final thickness of the TiN layer is below the construction tolerance of the implant, so that the dimensions of the implant remain unaltered.

The invention contemplates a second embodiment, of particular interest in case that the piece is a transepithelial piece, a healing cap, an abutment, a temporary cylinder, a titanium base for a ceramic, a locking screw or any other piece designed to be fitted in the area of an implant and a dental prosthesis in a patient's mouth. According to said second embodiment, the step of creating rugosities on the outer surface of the piece is carried out first, and the step of applying a TiN layer is carried out at a later stage. Initial rugosities provide the piece, regardless of its type, with improved integration conditions in the surrounding tissue that lead to more powerful tissue regeneration. Additionally, in the event that the piece is of the type that is to receive ceramic layers for the forming of a crown, initial rugosities improve the subsequent adhesion of the ceramic material. Similarly, the subsequent application of a TiN layer that respects the rugosities and does not conceal or homogenise them completely gives the piece a golden colour that provides an optimal aesthetic finish, similar to that of gold, with an estimated cost of between 2 and 5 times less than if the piece were made of gold. In addition, in the event that the TiN layer is applied on a piece designed to be disposed beneath a ceramic crown or abutment, the aesthetics are improved and an additional cost reduction is achieved. Cost reduction is due to the ceramic crown being able to be provided with less ceramic layers as would have been the case had there been a black or grey piece beneath the ceramic crown (ceramic crowns are mechanically very strong but are not very opaque and do not tend to conceal what is beneath them).

As a result, regardless of the order in which rugosities are created and the TiN layer is applied on the piece, the method of combining both techniques according to the invention provides significant advantages for the piece and for its use.

### BRIEF DESCRIPTION OF THE DRAWINGS

Details of the invention can be seen in the accompanying figures, which do not intend to limit the scope of the invention:

FIG. 1 shows an enlarged photograph of the surface of a machined piece coated with TiN.

FIG. 2 shows an enlarged photograph of the surface of a machined piece without a coating.

### DETAILED DESCRIPTION OF THE INVENTION

It is an object of the invention to provide a method of manufacture of a piece designed to be fitted in the area of a dental or transepithelial piece in the mouth of a patient. The method comprises steps of creating rugosities on the outer surface of a piece manufactured from titanium, stainless steel, gold or their alloys, and applying a layer of TiN on the piece.

In a first embodiment, the step of creating rugosities comprises the subjecting of the piece to an acid treatment. Because of the acid treatment, rugosities that are more uneven and lack a geometric pattern are created, while the size of the pore can be controlled more efficiently on a submicrometric scale. Additionally, the acid treatment may produce an open porosity, i.e., a condition where each pore is individually interconnected to each of the surrounding pores. This second aspect is particularly interesting when there is an aim is to securely fix adjacent tissue cells to the piece, for example, in case of an anchoring to bone tissue. This second aspect is also particularly interesting in order to ensure that a biomaterial applied on the surface so to provide the surface with a specific functionality does not come off while the piece is being implanted in the tissue during surgery. An example of an acid treatment may be found in patent no. U.S. Pat. No. 7,144,428.

In a second embodiment, the step of creating rugosities comprises the application of a laser treatment on the outer surface of the piece. The advantage of the laser treatment as a method for creating roughness or pores is that it may be carried out selectively on different areas of the surface of the implant. Additionally, a more geometrically perfect pattern or pore organization may be achieved, where shapes or patterns can be formed that contribute to improve the final aesthetic appearance of the prosthetic treatment.

With regard to the order in which the steps of creating rugosities and applying a TiN layer are carried out, the invention contemplates a first embodiment in which the step of applying a TiN layer is carried out first, and the step of creating rugosities on the outer surface of the piece is carried out at a later stage. This embodiment is especially suitable in the event that the piece to be manufactured is a dental implant, as the creation of rugosities allows controlling the thickness of the TiN layer and, therefore, the maximum thickness of the TiN layer to be precisely adjusted. Small and controlled thicknesses of the TiN layer help homogenise the surface of the implant, and therefore eliminate or hide marks, grooves, or similar that result from the machining process.

In this case, after the TiN layer is applied on the piece, the piece is optionally subjected to a surface treatment with acids to create smaller rugosities and a laser treatment to create larger rugosities, the aim being to favour implant interaction with the surrounding tissue. Having TiN applied allows the surface of the implant to be homogenised; such homogenisation is advisable prior to the application of the acid treatment because it allows creating a uniform substrate for which parameters such as times, concentrations, sequences, types of acids, etc. can be better adjusted. This makes the method more predictable, yielding micro- and nano-topography results within a narrower tolerance range, allowing the process to be validated according to medical product standards and good manufacturing practice.

In a second embodiment, the step of creating rugosities on the outer surface of the piece is carried out first, and the step of applying the TiN layer is carried out at a later stage. This embodiment is especially suitable for prosthetic components other than a dental implant. The fact that the aforementioned steps are carried out in said specific order allows achieving certain advantageous effects. On the one hand, since the rugosities do not alter the piece's base colour, better aesthetic results are obtained (as long as rugosities are controllably created, e.g. by controlling laser power in the event that rugosities are created by laser application, and the piece's material, e.g. titanium, is prevented from being ablated, which would cause the colour of the base material to fade or, even worse, would cause the piece to blacken). Thanks to the fact that rugosities do not alter the colour of the piece and that the subsequent application of the TiN layer gives the piece a golden colour, a very favourable aesthetic finish is provided. In addition, the TiN layer is very thin, as a result of which the texture or rugosity of the piece is conserved. On another hand, in the event that the piece is a ceramic titanium base or another piece designed to receive subsequent ceramic layers (generally made of lithium disilicate or zirconium), the adhesion of the ceramic is enhanced. In this respect, laboratory tests were carried out consisting in cementing a lithium disilicate ceramic crown to a texturized piece and to a non-texturized piece, both having an outer TiN layer, using a cement or composite marketed by Kuraray and known as “PANAVIA”. After a curing period, both pieces were transversally cut, cutting the ceramic, cement and base piece. Together with said cuts, mechanical traction tests were performed on an MTS test machine. Test results showed that 20% more force was required to separate layers in the case of the textured base piece, as the texturing provides a greater amount of surface area, thus improving adhesion, and also generates a topography that enhances the mechanical retention of the layers.

Preferably, the method according to the invention is characterised in that the laser application is carried out using a laser beam width of between 0.03 and 0.50 mm, with a power of between 60 and 80 kW, a speed of between 20 and 2,500 m/s, an impulse frequency of between 10,000 and 100,000 Hz, a defocus of +/−10 mm, and a beam width of between 0.01 and 1 mm.

The preceding method may be carried out, for example, with a “diode-pumped solid-state laser Nd:YAG 1064 nm” machine with a marking field (at f=160 mm) of 110 mm×110 mm. The rugosity is achieved by the engraving of the target area in accordance with a specific configuration of the following parameters: defocus, laser beam width, the power of the laser, marking speed and frequency, and the number and width of impulses. The homogeneous finish of the piece on its perimeter is possible thanks to a rotor synchronised with said laser, which rotates the piece as the laser is applied.

Additionally, the TiN layer is preferably applied in a vacuum chamber, at a maximum operating temperature of 600° C. and a chamber vacuum level of 0.001, the TiN layer presenting a micro-hardness (HK 0.01) of 2,300 and a coefficient of friction against steel (in dry conditions) of 0.4.

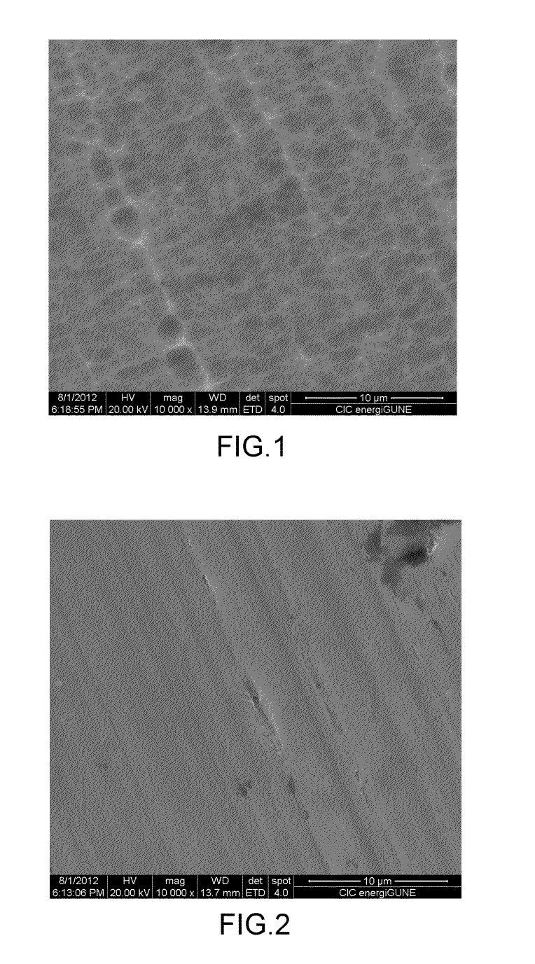

A very important advantage of the method according to the invention is that it reduces bacterial adhesion and even provides bacteriostatic effects. This may be observed in the photographs in FIGS. 1 and 2, which have been obtained by electronic microscopy at a scale factor of 10,000. FIG. 1 shows an enlarged image of the surface of a piece provided with a TiN layer, while FIG. 2 shows an enlarged image of the surface of a machined piece. As shown in FIG. 1, the surface provided with a TiN layer is homogeneous. In contrast, FIG. 2 shows a surface with marks (top right corner) and grooves (oblique lines) that are the result of the removal of shavings by the machining tool. These irregularities provide an environment in which bacteria may develop. It must be taken into account that the size of the bacteria is in the tens of microns, whereas the marks made by the machining tool are normally in the region of hundreds of microns, thus making them suitable places for bacteria to adhere and proliferate. The TiN layer, instead, succeeds in closing off these anchoring areas onto which bacteria may adhere and proliferate.

An additional advantage of the method is that it enables the piece to provide an improved biological response. To prove this advantage, a test was performed in which the biocompatibility of 1 mm-high transepithelial pieces, provided with an outer TiN layer with a controlled thickness of less than 4 microns and with roughness of less than 1 micron, in osteoblasts (MG63) and gingival fibroblasts (GX1) was measured. The test protocol followed the instructions given in the ISO10993-5, ISO 10993-1 and ISO 10993-12 standards. Out of the three test variants described in the standards (extract test/direct contact test/indirect contact test), the direct contact test option was chosen as a direct contact between the cell and the piece was considered to be the best way of simulating the actual environment where the piece will be inserted. The following equipment or tools were involved in the test: a laminar flow cabinet, a cell incubator, an inverted phase contrast microscope, a container of liquid nitrogen for storing cells, a centrifuge, a Neubauer cell counting chamber, a microplate reader, a thermostatic bath, a laminar flow hood, a variable volume micropipette, a refrigerator and a pipette controller. The following materials were also used: a 50 ml sterile Falcon conical centrifuge tube, 25 or 50 ml sterile plastic serological pipettes, latex gloves, sterile tips for micropipettes, culture flasks, a biological waste container, special gloves for handling liquid nitrogen, protective glasses, 1.5 ml sterile Eppendorf tubes, 48-well clear culture plates, 96-well clear culture plates, and sterile tweezers. As a positive control, cylindrical lead pieces measuring 5 mm wide and 7 mm high and highly cytotoxic in nature, as detailed in the literature (Cellular and molecular toxicity of lead in bone. Environ Health Perspect. 1991 February; 91:17-32), were used. In contrast, a biocompatible piece, in this case a culture plate coated in collagen, was the chosen negative control. Additionally, 70% ethanol (reagent grade), a complete culture medium for MG63 and GX1 cells, sterile PBS1X, 0.1% trypan blue and “cell proliferation reagent WST-1” (Roche: 05015944001) were used as reagents. The test procedure involved the cultivation of the MG63 osteoblast cells and GX1 gingival fibroblast cells around the pieces to be tested. Direct contact between the cells and the pieces lasted 48 hours, thereby giving enough time for possible cytotoxic effects on the cell culture to be detected. After 48 hours, the pieces being tested were removed and cellular viability analysed by means of the “Cell proliferation reagent WST-1” method. It was established that a reduction in the cellular viability of more than 30% would be considered a cytotoxic effect, in compliance with the “ISO10993-5 Biological evaluation of medical devices—Part 5: Tests for in vitro cytotoxicity” standard.

The results of the test were as follows.

The cellular viability of the piece provided with an outer TiN layer proved to be greater than that obtained for a piece not provided with a TiN layer. In other words, the cellular viability of the TiN layer did not decrease more than 30%; in fact, it increased. This applied to the two tested cell types. Specific numerical results are provided in the tables below. The values of the positive control (cytotoxicity), the negative control (biocompatibility), and the standard deviation (SD) show that the test was valid.

TABLE 1
Osteoblast viability (MG63)

| Sample | % viability | SD |
|---|---|---|
| Nitrided piece | 111.5 | 3.6 |
| Non-nitrided piece | 101.2 | 3.7 |
| Positive control | 1.6 | 0.2 |
| Negative control | 100 | 8.3 |

TABLE 2
Gingival fibroblast viability (GX1)

| Sample | % viability | SD |
|---|---|---|
| Nitrided piece | 94.2 | 3.1 |
| Non-nitrided piece | 90.6 | 9.4 |
| Positive control | 0.9 | 0.3 |
| Negative control | 100 | 0.3 |

It has also been proven that TiN provides pieces with radiopaque properties, making it easier to distinguish the pieces' outline when carrying out a CAT scan or an X-ray of a patient with pieces in his/her mouth, or when scanning a prosthetic layout on a plaster mould. In the latter, being able to obtain a more precise outline would open the door to more complex processes, such as detecting of a number of points on the outline, using a suitable algorithm to calculate to which prosthetic piece each point corresponds to, extracting the 3D image of the piece from a scanner library or other suitable software, and using the piece's 3D image in a 3D prosthetic planning design program.

1. Method of manufacture of a piece designed to be fitted in the area of a dental prosthesis in the mouth of a patient, characterised in that it comprises the steps of:
creating rugosities on the outer surface of a piece, the piece being manufactured from titanium, stainless steel, gold or their alloys;
applying a layer of TiN on the piece.

2. Method, according to claim 1, wherein the step of creating rugosities comprises subjecting the piece to an acid treatment.

3. Method, according to claim 1, wherein the step of creating rugosities comprises applying a laser treatment on the outer surface of the piece.

4. Method, according to claim 1, wherein the step of applying a layer of TiN on the piece is carried out before the step of creating rugosities on the outer surface of the piece.

5. Method, according to claim 4, wherein the step of creating rugosities comprises applying a laser treatment on the outer surface of the piece, and wherein the piece it is subjected to a surface treatment with acids after applying the layer of TiN and prior to applying the laser treatment.

6. Method, according to claim 1, wherein the step of creating rugosities on the outer surface of the piece is carried out before the step of applying a layer of TiN.

7. Method, according to claim 1, wherein the laser is applied with a beam width of between 0.03 and 0.5 mm, with a power of between 60 and 80 kW, a speed of between 20 and 2,500 m/s, an impulse frequency of between 10,000 and 100,000 Hz, a defocus of +/−10 mm, and a beam width of between 0.01 and 1 mm.

8. Method, according to claim 1, wherein the application of the layer of TiN is carried out in a vacuum chamber, at a maximum operating temperature of 600° C. and at a chamber vacuum level of 0.001, the layer of TiN presenting a microhardness (HK 0.01) of 2,300 and a coefficient of friction against steel, when dry, of 0.4.
